(19) United States
(12) Patent Application Publication
(10) Pub. No.: US 2003/0012902 A1
(43) Pub. Date: Jan. 16, 2003

(54) Compositions for sports equipment having laser-sensitive additives and methods of marking

(76) Inventors: Hyun Jin Kim, Carlsbad, CA (US); Benoit Vincent, Leucadia, CA (US)

Correspondence Address: Sheppard, Mullin, Richter & Hampton LLP, 48th Floor, 333 South Hope Street, Los Angeles, CA, 90071, US

(21) Appl. No.: 09/903,435

(22) Filed: Jul. 10, 2001

(51) Int. Cl. B32B 1/02; A63B 53/00; A63B 55/00; A63B 37/12; A63B 37/14

(52) U.S. Cl. 428/35.7; 473/282; 473/385

(57) ABSTRACT

Compositions and related methods are disclosed for improved laser marking of sports equipment. The compositions incorporate laser-sensitive additives into the compositions to allow for enhanced marking of the equipment using laser marking technology. Laser light is used to mark the equipment, leading to durable, clear markings. Use of the additives allows for marking without causing damage to the marked surfaces. Particular equipment incorporating the invention includes golf ball covers, golf ball containers, and golf club grips.

### BACKGROUND OF THE INVENTION

The invention relates generally to compositions for use in sports equipment and related methods for marking sports equipment incorporating these compositions. The compositions and methods provide for clearer, more durable markings than previous compositions and methods, with greater ease of processing.

Sports equipment incorporating polymers, either in its structural components or its coatings, includes golf balls and clubs, skis and ski boots, in-line skates, and many other articles. Sports equipment generally is marked with various logos, numbers, or other markings. Such equipment currently is generally marked using several direct printing methods, such as pad printing, ink jet printing, sublimation printing, embossing, or hot stamping.

Though these methods of direct printing are widely used, they present several disadvantages. Direct printing is a secondary operation performed after the initial molding of the equipment, leading to increased complexity and expense to manufacture the final product. Also, direct printing methods require use of solvents and inks because the printing process involves marking the equipment by imprinting its surface with aqueous or solvent-based inks. The chemicals used can require special handling procedures for manufacture or storage, and they also can release volatile organic compounds during production, requiring measures to comply with environmental regulations during manufacture. Theses special procedures and measures can result in increased time for and cost of manufacture of the sports equipment. Direct printing also provides for little flexibility in changing a design; a new printing plate must be created for each new design, leading to further cost increases due to the marking process.

Also, markings on a surface applied using direct printing rarely are durable and can have poor scratch and wear resistance. The normal wear and tear to which sports equipment is subjected can lead to quick fading or removal of direct printing. Marks that are produced by direct printing on equipment surfaces also can have poor solvent resistance. Therefore, use of any cleaning solvent or wax by the purchaser of the equipment can remove or fade any markings. To overcome these difficulties, direct printing can require that a solvent- and wear-resistant topcoat or other protective layer be placed over the printed decoration or logo, leading to added production complexity and expense. Additionally, use of direct printing also has limitations in terms of the resolution and quality of the images that can be printed on the equipment. The images produced can have low image density (i.e., the amount of information that can be embedded in a mark of given size) or low resolution, leading to markings that are either oversimplified or unclear.

An alternative method for marking sports equipment is by using laser marking. Laser marking employs a high-intensity beam of focused laser light to create a contrasting mark on the material surface. As the target material absorbs the laser light, the surface temperature increases to induce color change through carbonization of the material, or to displace material by vaporization to engrave the surface. Laser marking can be used for marking various materials, including polymers. Additionally, laser marking allows for greater flexibility in processing than other conventional methods, and the marked image also can be changed more quickly, reducing delays in production when such changes are made. The markings generally are clearer and more detailed than markings made using conventional methods. Additionally, products marked using laser technology can be more easily reground and melt-reprocessed than those marked using direct printing. Unlike direct printing processes, laser marking introduces no added materials to the surface product to achieve the printed image. Therefore, use of laser marking does not add impurities into the composition that can affect the ease of reprocessing or quality of the resulting material.

Laser marking can be performed on a surface coated with a primer, paint, a clear coating, or any other protective or decorative layer. The particular laser type and processing conditions, such as laser source, power, pulse and line speed, can be used for different surfaces and to achieve different effects. The particular marking can be prepared from a scanned bitmap image used to create a template for the laser. A variety of known laser systems can be used to induce these markings, including masking method beam-steered, and continuous beam systems. Lasers used can be continuous wave CO₂, transversal-exited atmospheric pressure CO₂, or beam-steered Neodymimn:Yttrium Aluminum Garnet, (Nd:YAG). One provider of suitable laser systems is Control Laser Corporation of Orlando, Florida. In particular, beam-steered systems employ mirrors mounted on high-speed computer-controlled galvanometers to direct the laser beam across the target surface. These systems can duplicate a wide range of vector graphic images with markings having small widths.

Despite its advantages over direct printing, use of laser marking methods to engrave the surface of sports equipment sufficient to produce a visible textual or graphic image can lead to degradation of the performance of the equipment, particularly when specially surface layers that are designed to maximize specific properties are so engraved. In these cases, it is undesirable to mark the surfaces using lasers to vaporize and engrave surface material. Known uses of lasers to induce sufficiently visible color change onto the surfaces of sports equipment also can lead to damage to these surfaces resulting from, for example, spontaneous depolymerization or carbonization of the surface material. Also, use of lasers in these known methods provides a very limited range of colors that can be induced in a given polymer material, based on the properties of the material itself.

In view of the difficulties discussed above, there remains a need for improved compositions and methods for marking of sports equipment that provide for durable, scratch-resistant marking of high-quality of logos and decorations without use of solvent processes or special handling, and without resulting in damage to the marked equipment. The present invention fulfills this need and other needs, and provides further related advantages.

### SUMMARY OF THE INVENTION

The present invention is embodied in sports equipment incorporating a composition comprising a polymer and an additive which enhances the color change of the composition resulting from the exposure of the composition to laser energy. In preferred embodiments of invention, the additive incorporates platelets having diameters ranging from about 2 to about 100 μm, wherein the platelets are made from mica and titanium oxide.

The composition comprises up to about 5% by weight of the additive, and more preferably from about 0.1% to about 3% by weight of the additive. A particular embodiment of the invention includes a golf ball cover composition comprising from about 0.1% to about 3% by weight of the additive. Other preffered embodiments include a golf ball container incorporating a composition comprising from about 0.1% to about 3% of the additive, and a grip for a golf club incorporating a composition comprising about 0.1% to about 3% of the additive.

Compositions of the sports equipment embodying the present invention also can incorporate colorants, fillers, fibers, antioxidants, UV stabilizers, compatabilizers, impact modifiers, processing aids, or combinations of these. Compositions of the sports equipment embodying the present invention can incorporate monomers, dimers, trimers, oligomers, polymers, or combinations of these.

The present invention also is embodied in a method for preparing marked sports equipment comprising preparing a composition comprising an additive which enhances the color change of the composition resulting from the exposure of the composition to laser energy, forming at least part of the sports equipment from the composition, and exposing a portion of the sports equipment formed from the composition to laser energy for a duration and of an intensity sufficient to effect color change of the exposed portion.

In certain embodiments of the method, the sports equipment is a golf ball, and the portion of the golf ball is exposed to laser energy produced by a laser apparatus operating at: a current of from about 5 to about 50 amperes, more preferably about 10 to about 50 amperes, most preferably about 10 to about 40 amperes; a pulse speed of from about 100 to about 10,000 Hz, more preferably about 500 to about 8,000 Hz, most preferably about 1,000 to about 6,000 Hz; and, a line speed of from about 1 to about 100 inches per second, more preferably about 2 to about 60 inches per second, most preferably about 4 to about 35 inches per second.

In another particular embodiment of the method, the sports equipment is a golf ball container, and the portion of the golf ball container is exposed to laser energy produced by a laser apparatus operating at: a current of from about 5 to about 50 amperes, more preferably about 10 to about 50 amperes, most preferably about 10 to about 40 amperes; a pulse speed of from about 100 to about 10,000 Hz, more preferably about 500 to about 8,000 Hz, most preferably about 1,000 to about 6,000 Hz; and, a line speed of from about 1 to about 100 inches per second, more preferably about 2 to about 60 inches per second, most preferably about 4 to about 35 inches per second.

In other embodiments of the method, the sports equipment is a golf club grip, and the portion of the golf club grip is exposed to laser energy produced by a laser apparatus operating at: a current of from about 5 to about 50 amperes, more preferably about 10 to about 50 amperes, most preferably about 10 to about 40 amperes; a pulse speed of from about 100 to about 10,000 Hz, more preferably about 500 to about 8,000 Hz, most preferably about 1,000 to about 6,000 Hz; and, a line speed of from about 1 to about 100 inches per second, more preferably about 2 to about 60 inches per second, most preferably about 4 to about 35 inches per second.

Other features and advantages of the present invention should become apparent from the following detailed description of the preferred embodiments.

### DESCRIPTION OF THE PREFERRED EMBODIMENTS

The present invention involves facilitating laser marking of sports equipment using laser-sensitive additives added into the materials of manufacture of the equipment. To facilitate marking in the present invention, the polymeric part, surface, or coating layer of the equipment to be marked is modified using additives and fillers that enhance laser marking by improving laser absorption in the polymer blend. These additives can be added in amounts small enough to not affect the critical manufacturing, physical, or aesthetic properties of the materials, while providing for improved laser marking of the finished product. When incorporated into surface layers, the additives can be satisfactorily incorporated into both liquid or powder coating materials without added difficulties in processing of the materials.

Use of these additives allows for marking without the severe vaporization or damage to the equipment surface that occurs from the excessive exposure to laser energy needed for satisfactory markings without using laser-sensitive additives. Also, these additives do not adversely affect reprocessing of the sports equipment. Unlike surface dyes used for direct printing of equipment, the laser-sensitive additives used in embodiments of the present invention are blended initially into the coating, protective layer, or component compositions of the equipment. As a result, the additives do not act as added impurities during regrinding or melt reprocessing, and therefore the advantages of laser marking over direct printing methods for recycling of materials is retained. The surface or component of the sports equipment incorporating the laser-sensitive additive can be coated with a protective layer essentially much less sensitive to the laser energy applied, without loss of effectiveness or damage to the protective layer during the laser marking process. Alternatively, addition of the laser-sensitive to a protective layer composition allows for marking of the protective layer without damage or discoloration other than the intended mark. It is also possible to produce an image that appears to protrude from the surface by incorporating a laser-sensitive additive into the composition of the part or protective layer and applying appropriate laser energy.

The compositions and methods of the present invention can be used as part of a combination approach to marking, combining marking using conventional carbonization of the equipment surface with marking using color change due to laser sensitive additives in the surface composition. For example, a surface can incorporate combinations of different colorants and laser-sensitive additives. A surface also can combine laser-sensitive additives with non-sensitive or less sensitive colorants to achieve a particular preferred color. Variations in color and intensity also can be made by controlling laser type and operating conditions, such as amperage, pulse frequency, and pulse duration. This broad variability in materials and processing conditions allows for marking of sports equipment that is readily tailored to particular requirements dictated by the composition and the marks required.

Additives capable of absorbing laser energy that can be used in the present invention include a variety of suitable materials, such as zeolite, cordierite, zirconium silicate, calcium silicate, mica, kaolin, talc, carbon black, and graphite. Each is selected based on the particular visual effect that is sought. Examples of suitable colorants that also can be used in the compositions include aluminum acetylacetone, ammonium vanadate, bismuth oxalate, bismuth oxide, chromium hydroxide, chromium oxide, cobalt oxalate, copper hydroxide, copper carbonate, cooper gluconate, copper oxalate, cuprous oxide, ferric hydroxide, lead phosphite, lead sulfite, red lead, nickel carbonate, nickel hydroxide, nickel formate, niobium oxide, titanium dioxide, metal titanates, titanium yellow, tungsten oxide, silver acetate, and stannous oxide. Organic pigments also can be used as colorants in the compositions. One or a combination of these is selected to produce markings of various colors. Compositions incorporating these laser-sensitive additives and colorants also can incorporate other materials commonly used in compositions for making sports equipment, such as fillers, fibers, antioxidants, UV stabilizers, compatabilizers, impact modifers and processing aids. The compositions also can incorporate low molecular weight chemicals, such as monomers, dimers, trimers, or oligomers, or combinations of these. Compositions incorporating these components are particularly suited for use in making coatings or protective layers for sports equipment.

Particularly preferred additives for use in the present invention include pigments based on mica/TiO₂. Examples of such additives are marketed by Merck AG of Frankfurt, Germany under the trade name IRIODIN LS. These additives are thin platelets with diameters ranging from 2 to 100μm, and they provide well-contrasted markings at low laser intensifies on a variety of standard plastics of various colors. A variety of IRIODIN LS additives are available for selection to match the particular polymer blend to be marked and the color desired.

A variety of laser types are suitable for use in the present invention, including pulsed metal vapor, solid state pulsed, excimer, and continuous wave, with or without pulse modification. Particularly preferred laser systems include continuous wave CO₂, transversal exited atmospheric pressure CO₂, and beam-steered Nd:YAG laser. Though more expensive than a CO₂ system, the beam-steered Nd:YAG provides the greatest versatility in materials to be marked and images generated. It is more preferred to use a pulsed Nd:YAG laser operating with a wavelength of 1064 nm, a frequency-doubled Nd:YAG laser, a pulsed TEA-CO₂ laser, and an excimer laser operating at a wavelength from 193 to 351 nm.

The use of laser marking methods with compositions containing laser-sensitive additives can be used for a variety of other sporting goods, including athletic shoes, skis, ski boots, bicycles, in-line skates, golf club grips, and any other equipment in which polymers are used into which a laser-sensitive dye can be incorporated. These methods are particularly preferred when use of conventional laser marking without laser-sensitive additives would damage a surface of the equipment that has been specially designed to maximize particular properties. An example of such equipment is a golf ball. Covers for golf balls are carefully chosen and manufactured to impart specific physical properties on the golf ball, including ball speed and spin rate, and they also are designed to be durable and have an aesthetically pleasing appearance. Conventional pad printed marks can lack durability on golf balls, but conventional laser marking methods damage the ball cover, leading to degradation of ball properties. Methods of the present invention allow for golf ball covers with durable, clear markings that do not cause damage and resulting degradation of properties.

### EXAMPLES

Marking on different types of sports equipment prepared using compositions within the scope of the present invention are illustrated below.

Golf Ball Cover

Golf ball covers were prepared within the scope of the present invention. In addition to a blend of ionomer and polyamide elastomer resins incorporating white colorant used in golf ball covers, the compositions prepared incorporated 0.5% to 2% of IRIODIN LS820. The laser used was a beam-steered Nd:YAG laser operating at a current of from 32 to 39 amperes with a pulse speed of from 1,000 to 6,000 Hz and a line speed of from 4 to 35 inches per second.

Use of LS820 produced visible markings on the covers. The markings produced on the ball covers were clear and sharp, and the marking process did not damage the cover layer. Also, the additive did not affect the physical properties of the cover layer beyond inducing color change.

Golf Ball Container Material

Materials for preparation of packaging for golf balls was prepared within the scope of the present invention.

Lids

Three differently colored plaques were prepared using an injection molding process with polypropylene, a material used to make lids for golf ball containers. The three plaques were prepared to appear as follows: (1) transparent with no color; (2) translucent with copper color; and (3) translucent with royal blue color. In addition to polypropylene and the particular colorants, the plaques prepared incorporated 0.5% by weight of IRIODIN LS850. Similar plaques also were prepared, except without addition of the LS850.

Side Walls

Differently colored plaques were prepared using an injection molding process with a blend of polyethylenes, a material used to make cylindrical wall sections for golf ball containers. In addition to the polyethylenes and the particular colorants, a number of the plaques were prepared incorporating 0.5% by weight of IRIODIN LS850.

The above-described plaques were then marked using a method within the scope of the present invention. The marking laser was a beam-steered Nd:YAG laser and operated at a current of 32 to 35 amperes, with a pulse speed of 3,000 to 4,000 Hz and a line speed of 10 to 20 inches per second.

Use of LS850 as an additive for the lid materials produced marks as follows: (1) olive-to-gray markings, by varying laser-marking conditions; (3) gray markings of various darknesses, by varying laser-marking conditions and (3) sky blue markings, including markings protruding from the surface, by varying laser-marking conditions. Exposure of lid materials not incorporating the LS850 additive to the same laser energy under the same conditions described above produced no visible markings.

Use of LS850 as an additive for the side wall materials produced gray markings of various darkness, by varying laser-marking conditions. The markings were clear and sharp. Exposure of side wall materials not incorporating the LS850 additive to the same laser energy under the same conditions described above produced no visible markings.

Golf Club Grip

Golf club grips can be prepared within the scope of the present invention. In addition to standard polymeric materials used in such grips, the compositions preferably incorporate 0.1% to 3% of IRIODIN LS820 or LS850. The laser preferred for use is a beam-steered Nd:YAG laser operating at a current of from 32 to 39 amperes with a pulse speed of from 1,000 to 6,000 Hz and a line speed of from 4 to 35 inches per second. Use of such compositions allows for laser marking of the grips using less laser energy than would be required using conventional methods, allowing for clear markings without causing damage to the grips.

A variety of other polymeric materials used in sports equipment, either in structural components or coatings, can incorporate laser-sensitive additives to facilitate improved marking of the equipment.

Although the invention has been disclosed in detail with reference only to the preferred embodiments, those skilled in the art will appreciate that additional methods of laser marking of equipment can be made without departing from the scope of the invention. Accordingly, the invention is defined only by the following claims.

We claim:

1. A golf ball cover comprising a polymer and an additive, wherein the additive enhances the color change of the golf ball cover resulting from the exposure of the golf ball cover to laser energy.

2. A golf ball cover as defined in claim 1, wherein the cover comprises up to about 5% by weight of the additive.

3. A golf ball cover as defined in claim 2, wherein the cover comprises from about 0.1% to about 3% by weight of the additive.

4. A golf ball cover as defined in claim 1, wherein the cover further comprises colorants, fillers, fibers, antioxidants, UV stabilizers, compatabilizers, impact modifiers, processing aids, or combinations of these.

5. A golf ball cover as defined in claim 1, wherein the cover further comprises monomers, dimers, trimers, oligomers, or combinations of these.

6. A golf ball cover as defined in claim 1, wherein the additive comprises platelets having diameters ranging from about 2 to about 100μm,
wherein the platelets comprise mica and titanium oxide.

7. Sports equipment incorporating a laser-sensitive composition comprising a polymer and an additive, wherein the additive enhances the color change of the composition resulting from the exposure of the composition to laser energy.

8. Sports equipment as defined in claim 8, wherein the laser-sensitive composition comprises up to about 5% by weight of the additive.

9. Sports equipment as defined in claim 8, wherein the laser-sensitive composition comprises from about 0.1% to about 3% by weight of the additive.

10. Sports equipment as defined in claim 9, wherein the laser-sensitive composition further comprises colorants, fillers, fibers, antioxidants, UV stabilizers, compatabilizers, impact modifiers, processing aids, or combinations of these.

11. Sports equipment as defined in claim 7, wherein the laser-sensitive composition further comprises monomers, dimers, trimers, oligomers, polymers, or combinations of these.

12. Sports equipment as defined in claim 7, wherein the additive is comprised of platelets having diameters ranging from about 2 to about 100μm, wherein the platelets comprise mica and titanium oxide.

13. Sports equipment as defined in claim 7, wherein the sports equipment is selected from the group consisting of golf balls, golf ball containers, golf clubs, shoes, skis, ski boots, bicycles, and skates.

14. A container for golf balls incorporating a laser-sensitive composition comprising from about 0.1% to about 3% by weight of an additive that enhances the color change of the composition when the composition is exposed to laser light.

15. A golf club grip incorporating a laser-sensitive composition comprising about 0.1% to about 3% of an additive that enhances the color change of the composition when the composition is exposed to laser light.

16. A method for preparing marked sports equipment comprising:
preparing a laser-sensitive composition comprising an additive which enhances the color change of the composition resulting from the exposure of the composition to laser energy;
forming at least a portion of the sports equipment from the laser-sensitive composition; and
exposing a segment of the portion of the sports equipment that is formed from the laser-sensitive composition to laser energy for a duration and of an intensity sufficient to effect color change of the exposed portion.

17. A method as defined in claim 16, wherein:
the sports equipment is a golf ball, and the portion of the golf ball formed from the laser-sensitive composition is a cover; and
the segment of the cover is exposed to laser energy produced by a laser apparatus operating at a current of from about 5 to about 50 amperes, a pulse speed of from about 100 to about 10,000 Hz, and a line speed of from about 1 to about 100 inches per second.

18. A method as defined in claim 17 wherein:
the segment of the cover is exposed to laser energy produced by a laser apparatus operating at a current of from about 10 to about 50 amperes, a pulse speed of from about 500 to about 8,000 Hz, and a line speed of from about 2 to about 60 inches per second.

19. A method as defined in claim 18 wherein:
the segment of the cover is exposed to laser energy produced by a laser apparatus operating at a current of from about 10 to about 40 amperes, a pulse speed of from about 1,000 to about 6,000 Hz, and a line speed of from about 4 to about 35 inches per second.

20. A method as defined in claim 16, wherein:
the sports equipment is a golf ball container; and
the segment of the portion of the golf ball container that is formed from the laser-sensitive composition is exposed to laser energy produced by a laser apparatus operating at a current of from about 5 to about 50 amperes, a pulse speed of from about 100 to about 10,000 Hz and a line speed of from about 1 to about 100 inches per second.

21. A method as defined in claim 20, wherein:
the segment of the portion of the golf ball container that is formed from the laser-sensitive composition is exposed to laser energy produced by a laser apparatus operating at a current of from about 10 to about 50 amperes, a pulse speed of from about 500 to about 8,000 Hz and a line speed of from about 2 to about 60 inches per second.

21. A method as defined in claim 21, wherein:
the segment of the portion of the golf ball container that is formed from the laser-sensitive composition is exposed to laser energy produced by a laser apparatus operating at a current of from about 10 to about 40 amperes, a pulse speed of from about 1,000 to about 6,000 Hz and a line speed of from about 4 to about 35 inches per second.

22. A method as defined in claim 16, wherein:
the sports equipment is a golf club grip; and
the segment of the portion of the golf club grip that is formed from the laser-sensitive composition is exposed to laser energy produced by a laser apparatus operating at a current of from about 5 to about 50 amperes, a pulse speed of from about 100 to about 10,000 Hz, and a line speed of from 1 to 100 inches per second.

23. A method as defined in claim 22, wherein:
the segment of the portion of the golf club grip that is formed from the laser-sensitive composition is exposed to laser energy produced by a laser apparatus operating at a current of from about 10 to about 50 amperes, a pulse speed of from about 500 to about 8,000 Hz, and a line speed of from 2 to 60 inches per second.

24. A method as defined in claim 23, wherein:
the segment of the portion of the golf club grip that is formed from the laser-sensitive composition is exposed to laser energy produced by a laser apparatus operating at a current of from about 10 to about 40 amperes, a pulse speed of from about 1,000 to about 6,000 Hz, and a line speed of from 4 to 35 inches per second.
